(19) United States
(12) Patent Application Publication
(10) Pub. No.: US 2011/0231895 A1
(43) Pub. Date: Sep. 22, 2011

(54) Systems and Methods for Mediating Internet Service

(76) Inventor: Tom C. Tovar, San Francisco, CA (US)

(21) Appl. No.: 12/897,468

(22) Filed: Oct. 4, 2010

Related U.S. Application Data
(63) Continuation-in-part of application No. 12/727,001, filed on Mar. 18, 2010.
(60) Provisional application No. 61/370,556, filed on Aug. 4, 2010.

(51) Int. Cl. G06F 21/00; H04L 9/32

(52) U.S. Cl. 726/1; 726/7

(57) ABSTRACT

Systems and methods for an Internet service delivered to a particular location are provided herein. Exemplary methods for mediating an Internet service include executing instructions stored in a memory by a processor to selectively apply, on-demand, a mediation policy to the Internet service, the mediation policy adapted to prevent the delivery of Internet content for a predetermined period of time. The method may include establishing a user interface between a computing system and Internet service, the user interface receiving a request to apply the mediation policy to the Internet service via the user interface to prevent the delivery of Internet content for a predetermined period of time.

### CROSS-REFERENCE TO RELATED APPLICATIONS

This nonprovisional patent application is a continuation-in-part application that claims the priority benefit of U.S. patent application Ser. No. 12/727,001 filed on Mar. 18, 2010, titled “Internet Mediation,” and provisional U.S. Patent Application Ser. No. 61/370,556, filed on Aug. 4, 2010, titled “Internet Mediation Applications,” which are hereby incorporated by reference in their entirety.

### FIELD OF THE INVENTION

The present invention relates generally to mediating an Internet service, and more specifically, but not by way of limitation, to systems and methods that selectively apply, on-demand, a mediation policy to the Internet service, the mediation policy adapted to prevent the delivery of Internet content for a predetermined period of time.

### SUMMARY OF THE INVENTION

According to exemplary embodiments, the present invention provides methods for mediating an Internet service including executing instructions stored in a memory by a processor to selectively apply, on-demand, a mediation policy to the Internet service, the mediation policy adapted to prevent the delivery of Internet content for a predetermined period of time.

According to other exemplary embodiments, the present invention is directed to systems for mediating an Internet service including a memory for storing a mediation policy application and a processor for executing the mediation policy application to selectively apply, on-demand, a mediation policy to the Internet service, the mediation policy adapted to prevent the delivery of Internet content for a predetermined period of time.

According to additional exemplary embodiments, the present invention is directed to computer readable storage media having a program embodied thereon, the program executable by a processor in a computing system to perform methods for mediating an Internet service by executing instructions stored in a memory by a processor to selectively apply, on-demand, a mediation policy to the Internet service, the mediation policy adapted to prevent the delivery of Internet content for a predetermined period of time.

### BRIEF DESCRIPTION OF THE DRAWINGS

FIG. 1 is an exemplary architecture of a mediation policy application in accordance with various embodiments of the present invention.

FIG. 2 is a flow chart of an exemplary method for selectively applying a mediation policy to an Internet service.

FIG. 3 is an exemplary representation of a web page for subscribing to the mediation policy application.

FIG. 4A is an exemplary representation of a web page such as a configuration drawer for selectively applying a mediation policy.

FIG. 4B is an exemplary representation of a blocking web page.

FIG. 5 is a block diagram of a DNS network arrangement in accordance with various embodiments of the present invention.

FIG. 6 is a block diagram of an exemplary system for providing variable content control for Internet user in accordance with various embodiments of the present invention.

FIG. 7 is a block diagram of an exemplary system for providing notifications regarding Internet access in accordance with various embodiments of the present invention.

### DETAILED DESCRIPTION OF EXEMPLARY EMBODIMENTS

While this invention is susceptible of embodiment in many different forms, there is shown in the drawings and will herein be described in detail several specific embodiments with the understanding that the present disclosure is to be considered as an exemplification of the principles of the invention and is not intended to limit the invention to the embodiments illustrated. According to exemplary embodiments, the present technology is directed to systems and methods for mediating the delivery of Internet service. The systems and methods selectively apply a mediation policy to the Internet service to prevent the delivery of Internet content for a predetermined amount of time. Moreover, the functionality of applying the mediation policy is available on-demand in that an administrator may enable application of the mediation policy at any time.

Generally speaking, an administrator may selectively apply a mediation policy to the Internet service, the mediation policy affecting one or more end users that utilize computing systems coupled to the Internet service delivered to a location, such as a home, residence, place of business, campus, etc. The term “administrator” may include not only individuals, such as parents, but also any individual creating a mediation policy regarding the Internet service delivered to end users. It will be understood that an administrator may also be an end user, although end users who are not also administrators may not typically create or selectively apply mediation policies.

It will be further understood that because of the diversity of computing systems that may connect to the Internet service, the mediation policy may be applied to the Internet service itself. The mediation policy is therefore not required to affect each computing system individually, such as a mediation policy application resident on each computing system. In various exemplary embodiments a mediation policy (or at least a portion of the mediation policy application) may also reside on one or more of the computing systems.

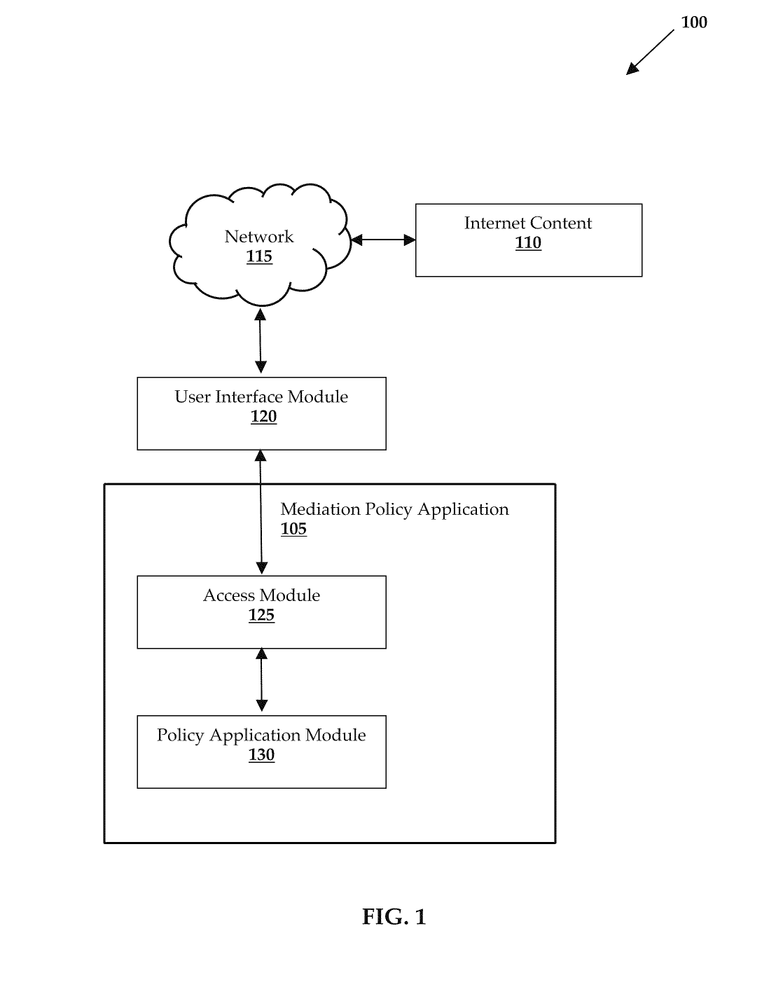

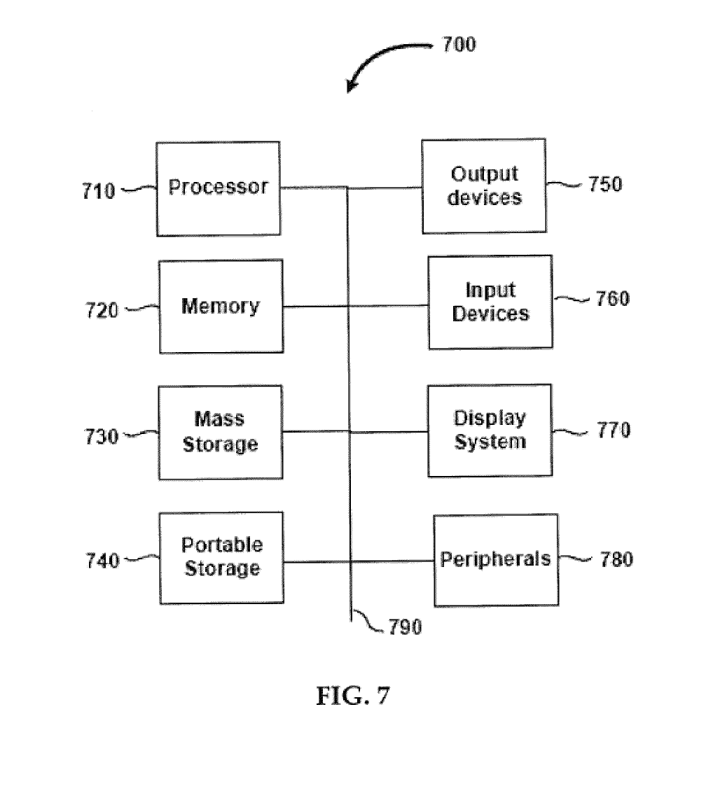

Referring now to FIG. 1, an exemplary architecture 100 of an exemplary mediation policy application 105 resident on the computing system (described in greater detail in FIG. 7 as computing system 700) is shown. The computing system 700 may access the Internet content 110 for Internet content 110 by way of a common Internet connection (not shown) operatively coupling each computing device within a particular location. Common types of Internet connections include cable and DSL modems, and the like.

The computing system 700 may access Internet content 110 via network 115 (by way of the Internet connection) utilizing user interfaces generated by the user interface module 120. Generally speaking, the mediation policy application 105 allows an administrator to selectively apply a meditation policy to the Internet service to prevent the delivery of Internet content 110 for a predetermined amount of time.

It is important to note that the mediation policy application does not simply provide blocking mechanisms by masking or enabling network controls, but rather mediates delivery of the Internet service. As used herein, mediating the Internet service may include any of blocking, constraining, enabling, redirecting, promoting, demoting, substituting, obscuring, limiting, interrupting, and restricting all or a portion of the Internet service.

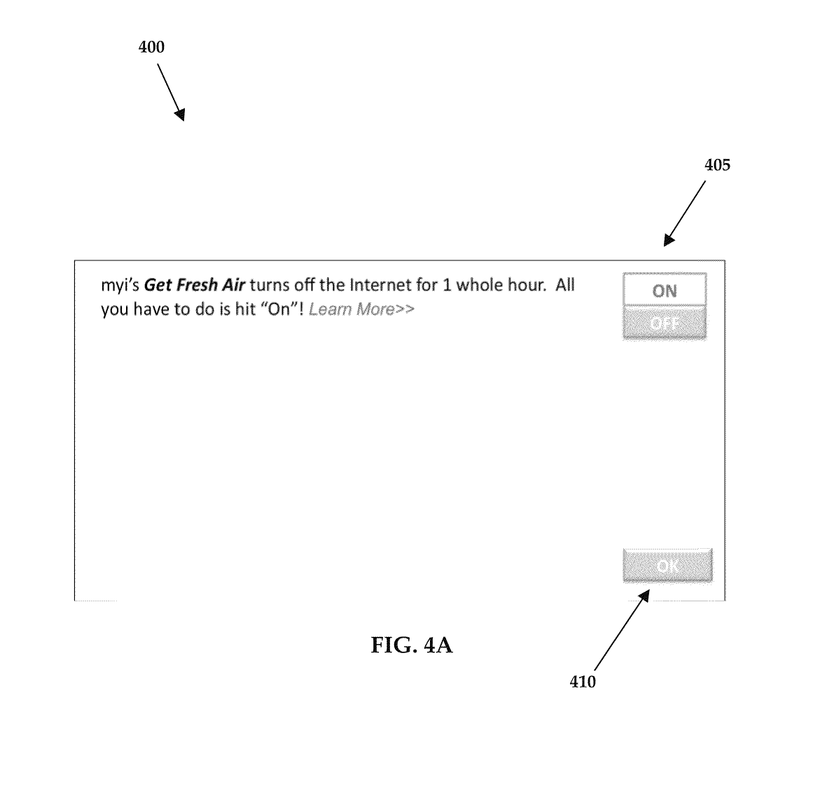

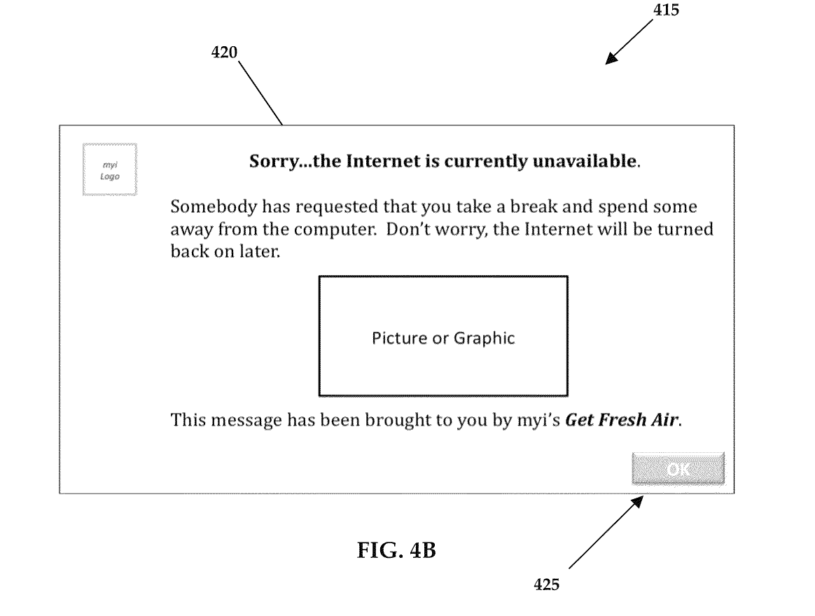

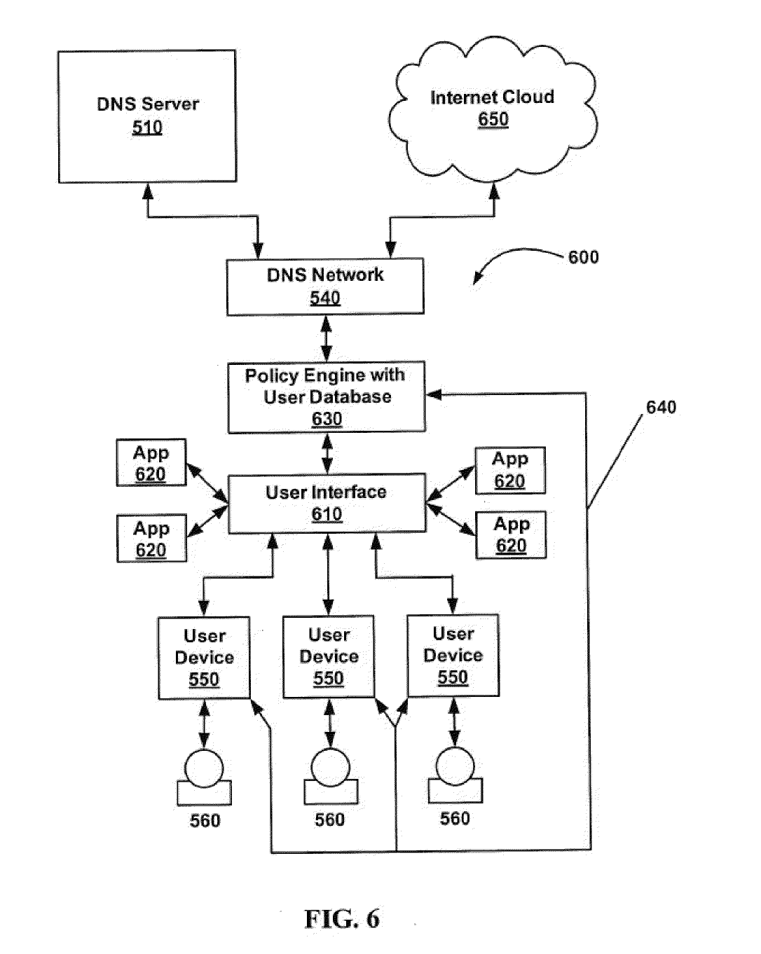

According to exemplary embodiments, the mediation policy application 105 allows for the selective application of mediation polices on-demand, via a user interface such as a web page. The mediation policy application 105 may also be provided in a standalone application that is launched, without the use of a web browser, to perform a specific task, activity, or service. A user interface module 120 may generate the user interface 610 (described in conjunction with FIG. 6). The user interface 610 may be implemented in many embodiments, although in various exemplary implementations, the user interface 610 includes web page 400 adapted to receive input from an administrator, as illustrated in FIG. 4A. Although not shown, access to the mediation policy via the user interface 610 may be password protected to prevent end users from accessing the user interface 610 and disabling application of the mediation policy. Therefore, prior to accessing the user interface 610, an end user may be prompted to enter a password, as will be discussed in greater detail herein.

According to exemplary embodiments, the mediation policy application 105 may include an access module 125 and a policy application module 130. It is noteworthy that the mediation policy application 105 may be composed of more or fewer modules and engines (or combinations of the same) and still fall within the scope of the present technology.

In general, the access module 125 controls access to a user interface generated by the user interface module 120. Upon an attempt to access web page 400, the access module 125 prompts the end user to enter a password. The access module 125 is adapted to receive input indicative of a password, evaluate the received input, and provide access to a mediation policy upon authentication of the received input. It will be understood that an established password may be created according to any number of commonly utilized methods, for example, providing the administrator with ability to create an administrator-defined password. Moreover, other types of systems and methods for authenticating access to computer programs or applications that would be known to one or ordinary skill the art with the present disclosure before them are likewise contemplated for use in accordance with the present invention.

Upon authentication, the user interface module 120 generates and outputs a web page 400 that may be utilized by the administrator to selectively apply the mediation policy to the Internet service on-demand. When applied to the Internet service, the mediation policy prevents the resolution of Internet content for a predetermined amount of time. Upon expiration of the predetermined period of time, the policy application module 130 disables application of the mediation policy to the Internet service. It will be understood that rather than waiting until the expiration of the predetermined amount of time, the administrator may disable application of the mediation policy on-demand via the web page 400.

Because of the potential diversity of end users that may access the Internet service at a given location, the administrators may apply the mediation policy on a more granular, or end user specific basis. For example, a parent who desires to prevent their children from accessing the Internet service for a predetermined amount of time, while preserving the ability of other adults to access the Internet service may choose to selectively apply the mediation policy on a granular level to specific end users, i.e. his children.

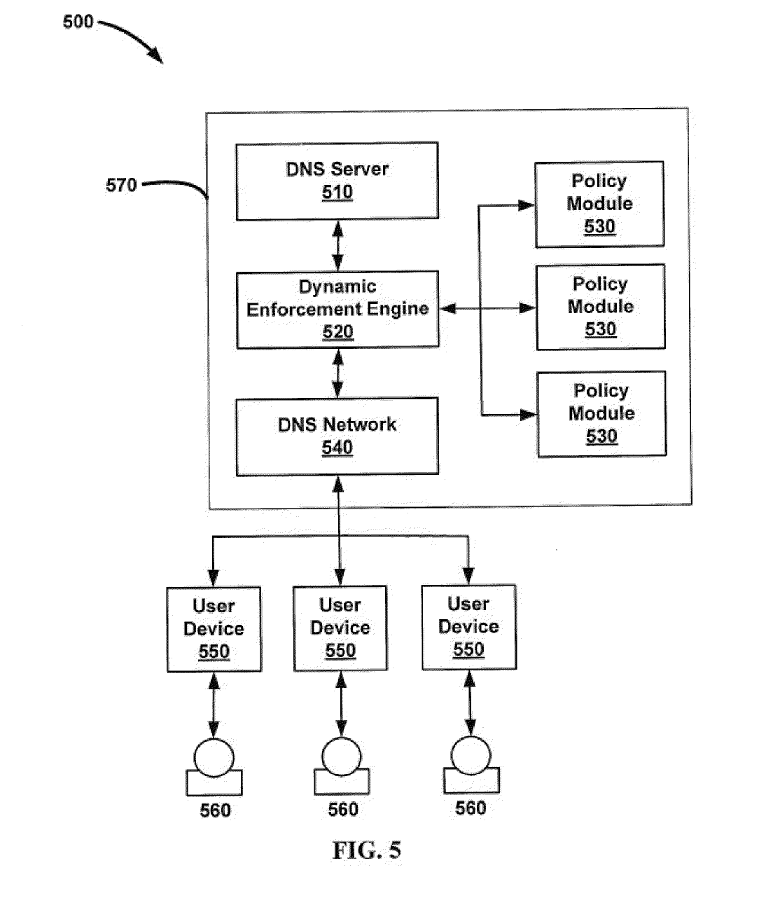

Regardless of whether the mediation policy is applied to the Internet service on a universal or granular basis, the policy application module 130 applies the mediation policy to the Internet service and evaluates requests to access Internet content 110 received from a computing system operatively coupled to the Internet service via the Internet connection. If an end user requests Internet content 110 when application of the mediation policy is enabled, the policy application module 130 causes the dynamic enforcement engine 520 (FIG. 5) to perform at least one of the following actions: (1) prevent the DNS server 510 (FIG. 5) from resolving the Internet content 110 before the Internet service reaches the displays of the user devices 550 (FIG. 5); or (2) prevent the Internet service provider from resolving the Internet content 110 before the Internet service reaches the displays of the user devices 550. In the first case, the dynamic enforcement engine 520 may prevent the DNS server 510 from resolving the Internet content 110 by affecting commands and actions occurring on the DNS server 510. It will be understood that the policy application module 130 may reside on the DNS server 510.

The administrator, via utilization of the user interface 610, may terminate application of the mediation policy to the Internet service at any time. The user interface 610 may include a button (such as an enable/disable button 410 of exemplary FIG. 4A) or a check box that can be toggled by the administrator to enable/disable the application of the mediation policy to the Internet service.

Additionally, if the dynamic enforcement engine 520 has denied access to Internet content 110, the policy application module 130 may cause the user interface module 120 to generate a user interface 610 in the form of a web page 420 (see FIG. 4B) that includes a blocking message. According to various embodiments, the user interface 610 includes a web page notifying the end user that access to the requested Internet content 110 has been denied by the mediation policy application 105.

According to other embodiments, the database may be used by the policy application module 130 to record and to notify administrators of various data relative to Internet access. The data collected from and provided to the administrators may include records of specific instances when access to Internet content 110 was blocked, such as when the dynamic enforcement engine 520 prevents resolution of requested Internet content 110. Additionally, the policy application module 130 may record an aggregate number of times Internet content 110 was blocked in a predetermined amount of time. The data collected may be organized into logs that can be stored in a user record and accessed by the user interface module 120. More specifically, the user interface module 120 may generate a web page (not shown), including log data indicative of the date and time resolutions of Internet content 110 that were denied, along with information indicative of the Internet content 110.

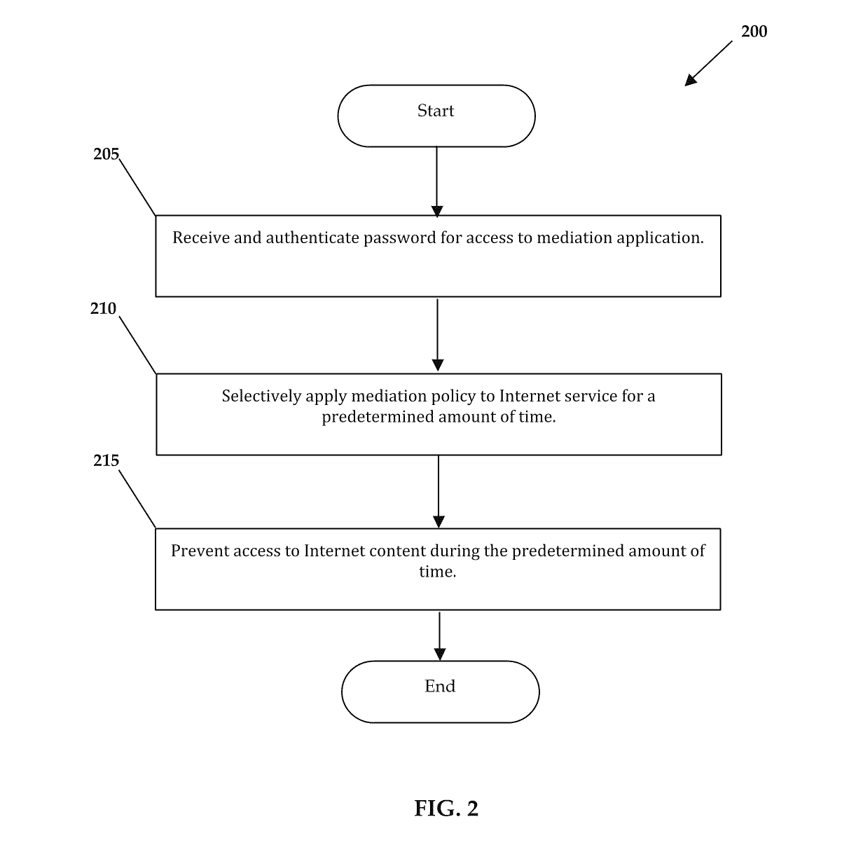

Referring now to FIG. 2, a method 200 for selectively applying a mediation policy to an Internet service is illustrated. The method 200 begins with a step 205 wherein an administrator accessing a user interface for selectively applying a mediation policy enters a password that is then evaluated by the access module. If the access module authenticates the password, the user interface module generates and outputs the user interface that may be utilized by the administrator to selectively apply the mediation policy to the Internet service on-demand.

If the administrator enables application of the mediation policy, the method 200 proceeds to step 210 that includes the policy application module applying the mediation policy to the Internet service for a predetermined amount of time.

In step 215, the mediation policy is applied to the Internet service to prevent delivery of Internet content for the predetermined amount of time. More specifically, each application of a mediation policy begins with an end user inputting a request to access Internet content. The end user may input this request via a browser operating on the user device. In various embodiments, the request may also include clicking a hyperlink.

If the policy application module determines that application of the mediation policy to the Internet service has been enabled, the policy application module causes the dynamic enforcement engine to prevent resolution of the Internet content.

In addition to preventing resolution of the requested Internet content, the policy application module may display a notification message to the end user in the form of a blocking web page. It will be understood that the user interface module may generate the blocking web page. The blocking web page may include the following content: a message that the attempt to access the requested Internet content has been denied; a message that the attempt was blocked by the mediation policy application (which may include the trade name of the application); a message that the administrator has established that the requested Internet content be blocked; and/or any combination thereof. The method 200 terminates after the dynamic enforcement engine prevents resolution of the Internet content and/or the user interface module generates and displays a notification message.

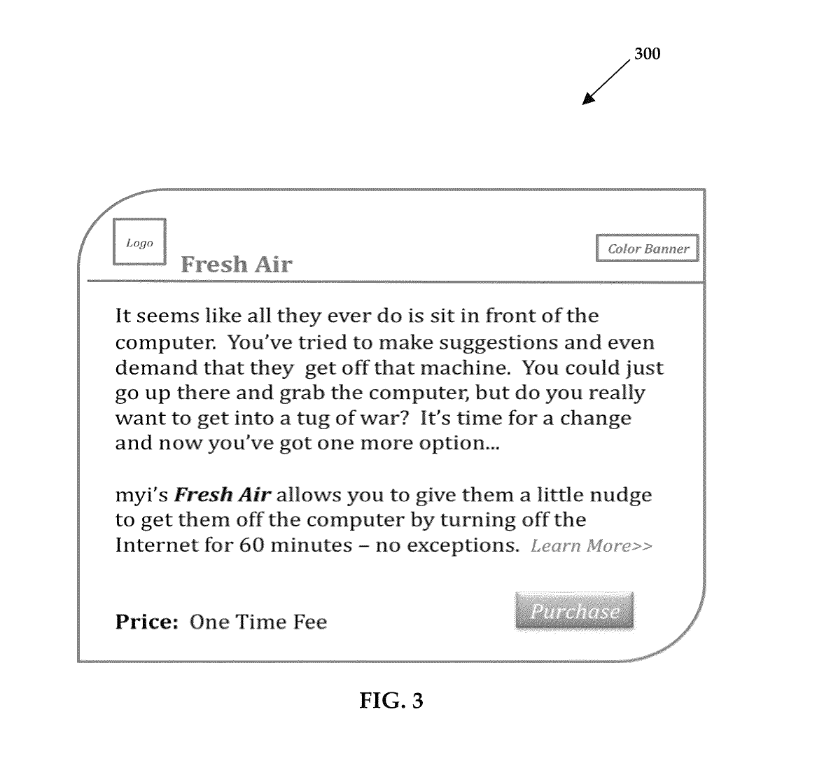

FIG. 3 illustrates an exemplary web page 300 for subscribing to the mediation policy application. The web page may include (i) content describing the functionality of the application; (ii) the name of the application (“Break Time”); (iii) a link to more detailed information; and (iv) a price description.

FIG. 4A illustrates an exemplary user interface, which in this instance includes a web page 400 in the form of a configuration drawer by which a plurality of input devices may be configured to receive input from an administrator. The web page 400 may include instructional text that explains the functionality associated with one or more enable/disable buttons 405 located on web page 400. More specifically, the enable/disable button 405 allows an administrator to enable/disable application of the mediation policy to the Internet service. Once the administrator has enabled or disabled application of the mediation policy, the administrator may utilize button 410 to close the web page 400.

FIG. 4B illustrates an exemplary user interface, which in this instance includes a blocking page 415. The blocking page 415 may include a message 420 that an attempt to access the requested Internet content has been denied along with the name of the restricted Internet content. It will be understood that the mediation policy application 105 and the blocking page 415 may be adapted to prevent the end user from bypassing the blocking page 415 to access the Internet content. Once the end user has finished viewing the blocking page, the end user may utilize button 425 to close the blocking page 415.

The systems and methods described above may typically be resident in an Internet service or a DNS network. The systems and methods described may also be implemented in plug-in utilities, gateway devices, cable modems, proxy servers, set top boxes, and network interface devices.

FIG. 5 illustrates an exemplary Internet service system 500, with a DNS server, that may be utilized to support the above described systems and methods. A DNS server 510 operates in conjunction with a dynamic enforcement engine 520. The dynamic enforcement engine 520 may operate in conjunction with one or more policy modules 530 to establish any applicable polices at the DNS level. The content rules are applied to received user queries, and determine the content that is delivered by the DNS network 540 through various user devices 550 to the end users 560.

Exemplary user devices for use with the disclosed systems may include an app. As used herein, an app shall be defined as a module including a user interface to the Internet service. The app may further include one or more modules included in the Internet service. An app may be downloaded and installed on a user's computing device, including mobile devices. Users may define an access, mediation, or restriction policy via a user device, such as through the user interface. Some embodiments of the present invention do not require software to be downloaded or installed locally to the user device and, accordingly, do not require the user to execute a de-install application to cease use of the system.

The dynamic enforcement engine 520 may generate its policy engine on instructions received from one or more policy modules 530. Each policy module 530 may be constructed to provide various types and levels of services to the DNS network 540. In various embodiments, a policy module 530 may be configured to handle queries directed to subjects including, but not limited to, malicious domain redirection, user access redirection, non-existent domain redirection, and data collection or analysis.

It will be recognized by those skilled in the art that the elements of DNS service 570 may be hosted either locally or remotely. In addition to residing in the DNS service 570, one or more of the DNS network 540, the dynamic enforcement engine 520, and the policy modules 530, and any combination thereof, may be resident on one or more user devices 550.

FIG. 6 shows a schematic layout of an exemplary system 600 for implementing direct and variable end user control. FIG. 6 illustrates that the system 600 may operate installed on a DNS server 510, or with a cloud 650 based installation.

The system 600 utilizes a user interface 610. The user interface 610 may be implemented in many embodiments. One specific implementation of the user interface 610 is as a web page.

The user interface 610 may be accessed by one or more user devices 550 operated by the users 560. The user interface 610 may be accessed though a gateway user device 550 available to the users 560. Suitable user devices 550 include but are not limited to desktops, PCs, laptops, notebooks, gaming devices, IPods, Smartphone, automobile computing systems, and Internet enabled TVs. The system 600 may also be deployed, accessed and controlled remotely through user devices 550, such as a Smartphone or other specialized access device. A Smartphone may be defined as a phone with computing capability. A Smartphone may provide the user 560 with Internet access.

The user interface 610 provides a mechanism for one or more authorized users 560 to establish content policy for the Internet service. The user interface 610 operates between the user devices 550 present in the system 600 and the DNS network 540. Instructions resident on the user interface 610 therefore operate on the Internet service, by controlling at least a portion of DNS resolutions via a dynamic policy engine 630, before the service reaches the displays of the user devices 550.

The user interface 610 provides the users 560 with access to one or more policy applications 620. The user interface 610 may provide access to a selection list to at least one authorized user 560. The authorized user 560 uses the selection list or some other menu mechanism to select those policy applications 620 that the user 560 chooses to apply to the system 600. The authorized user 560 may select any number of the available policy applications for use on the system 600 at any given time. In implementations utilizing smartphones as the user device 550, the policy applications 620 are downloaded to the device 550. The device 550 then serves as the user interface 610 to communicate directly with the dynamic policy engine 630.

The policy applications 620 may prohibit access to specific sites. The policy applications 620 may also limit the time of day when users or selected users 560 may access certain sites. The policy applications 620 may also manage and analyze duration of access to various sites. It is important to note that the policy applications 620 do not simply provide blocking mechanisms by masking or enabling network controls, but rather mediate an Internet service received by the end user. The policy applications may be discrete applications and may be single purpose applications. The applications may be configured to meet the needs, rules and behaviors desired by the administrator. The administrator may select one or more policy applications from a selection menu to provide an individualized Internet experience for the end user or his household. As used herein, mediating the service may include any of blocking, constraining, enabling, redirecting, promoting, demoting, substituting, obscuring, limiting, interrupting, and restricting all or a portion of the Internet service. The policy applications 620 may provide notifications or alerts to one or more users 560 when sites are accessed. The policy applications 620 may also provide notification of frequency and duration of access of designated sites. The policy applications 620 may also be used to observe, substitute, enable, redirect users, to reward behavior desired from the users by a system administrator, etc. The policy applications 620 may redirect users from a non-favored site to another site. The policy applications 620 may also collect and transmit data characteristic of Internet use.

Access policies supplied by the policy applications 620 may apply to all users 560 of the system 600, or the access policies may be specific to individual users or groups of users 560. The policy applications 620 may be discrete, single purpose applications.

The policy applications 620 provide the users 550 with a mechanism to take various actions relative to their Internet service feed. The policy applications 620 also allow the users 550 to establish a dynamic policy engine 630 that includes a user database. The policy engine 630 is used to enforce rules associated with each policy application associated with individual end users, not simply block various inappropriate sites from the Internet feed. Rather, the dynamic policy engine 630, controlled by the user interface 610 through user device(s) 550, is used to manage all aspects of the Internet experience for the users 560. In sum, the policy applications 620 may be used to configure the dynamic policy engine 630 to provide the users 560 with a mechanism to personalize the Internet experience. The policy applications 620 may be configured in combinations, and may each be separately configured.

The database in the policy engine 630 may be used to record and to notify users 560 of various data relative to Internet access. The data collected from and provided to the users 560 may include records of access of specific sites, time spent on specific sites, time of day of access, data specific to individual users, etc.

It should also be noted that following an initial setup through the user interface 610 of the policy engine 630, a direct access 640 enforcement loop may be established between the policy engine 630 and the user devices 550. Subsequent accessing of the DNS network 540 utilizing the direct access 640 decreases response time in the system 600, thereby further enhancing the Internet experience of the users 560. Configurations of policy applications 620 that are selected by one or more users 560 designated as system administrators may remain in the user database of the policy engine 630 until such time as it may be modified by the system administrators. The system administrators may define multiple policy configurations, with a combination of policy applications 620, applicable to one or more end users 560 of the system 600. Each policy application 620 may be separately configurable as well. Policy configurations may vary based upon designated times, conditional triggers, or specific requests from the users 560 with administrative authority.

As indicated above, two discrete data flow paths may be established for the system 600. A first data path establishes a set of enforcement policies for the system 600. The first data path flows from at least one user device 550 through the user interface 610, to the policy enforcement engine 630. A second data path 640 may be utilized following the establishment of a set of policies for the system 600. The second data path 640 flows directly between the user device(s) 550 and the policy engine 630. Multiple sets of enforcement policies may be established and saved within the system 600 and implemented selectively by the users 560.

FIG. 7 illustrates an exemplary computing system 700 that may be used to implement an embodiment of the present invention. System 700 of FIG. 7 may be implemented in the context of user devices 550, DNS server 510, Internet cloud 650 and the like. The computing system 700 of FIG. 7 includes one or more processors 710 and memory 720. Main memory 720 stores, in part, instructions and data for execution by processor 710. Main memory 720 can store the executable code when the system 700 is in operation. The system 700 of FIG. 7 may further include a mass storage device 730, portable storage medium drive(s) 740, output devices 750, user input devices 760, a graphics display 740, and other peripheral devices 780.

The components shown in FIG. 7 are depicted as being connected via a single bus 790. The components may be connected through one or more data transport means. Processor unit 710 and main memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present invention for purposes of loading that software into main memory 710.

Portable storage device 740 operates in conjunction with a portable non-volatile storage medium, such as a floppy disk, compact disk or Digital video disc, to input and output data and code to and from the computing system 700 of FIG. 7. The system software for implementing embodiments of the present invention may be stored on such a portable medium and input to the computing system 700 via the portable storage device 740.

Input devices 760 provide a portion of a user interface. Input devices 760 may include an alphanumeric keypad, such as a keyboard, for inputting alphanumeric and other information, or a pointing device, such as a mouse, a trackball, stylus, or cursor direction keys. Additionally, the system 700 as shown in FIG. 7 includes output devices 750. Suitable output devices include speakers, printers, network interfaces, and monitors.

Display system 770 may include a liquid crystal display (LCD) or other suitable display device. Display system 770 receives textual and graphical information, and processes the information for output to the display device.

Peripherals 780 may include any type of computer support device to add additional functionality to the computing system. Peripheral device(s) 780 may include a modem or a router.

The components contained in the computing system 700 of FIG. 7 are those typically found in computing systems that may be suitable for use with embodiments of the present invention and are intended to represent a broad category of such computer components that are well known in the art. Thus, the computing system 700 of FIG. 7 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art. For example, this description describes the technology in the context of an Internet service in conjunction with a DNS server. It will be appreciated by those skilled in the art that functionalities and method steps that are performed by a DNS server may be performed by an Internet service, and vice versa.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

One skilled in the art will further appreciate that the term “Internet content” comprises content accessed by an user device and may include one or more of web sites, domains, web pages, web addresses, hyperlinks, URLs, any text, pictures, and/or media (such as video, audio, and any combination of audio and video) provided or displayed on a web page, and any combination thereof. Mediation policy may include any of blocking, constraining, enabling, redirecting, promoting, demoting, substituting, limiting, interrupting.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or subcombinations. Each of these processes or steps may be implemented in a variety of different ways. Also, while processes or steps are at times shown as being performed in series, these processes or steps may instead be performed in parallel, or may be performed at different times.

From the foregoing, it will be appreciated that specific embodiments of the system have been described herein for purposes of illustration, but that various modifications may be made without deviating from the spirit and scope of the system. Accordingly, the disclosure is not limited except as by the appended claims.

What is claimed is:

1. A method for mediating an Internet service at a selected location, the method comprising:
establishing a user interface between a computing system and the Internet service;
receiving a request to access the Internet service via the user interface; and
applying a mediation policy in response to the request by executing via a processor instructions stored in a memory to selectively apply, on-demand, the mediation policy to the Internet service, the mediation policy being adapted to completely prevent the delivery of Internet content for a predetermined period of time.

2. The method according to claim 1, wherein at least one element of the mediation policy is resident on a DNS server.

3. The method according to claim 1, wherein at least one element of the mediation policy is enforced by a DNS server.

4. The method according to claim 1, wherein the mediation policy is established and altered only by an administrator.

5. The method according to claim 1, wherein before establishing the user interface between a computing system and Internet service, the method includes receiving information authenticating the received information.

6. The method of claim 1, wherein an administrator can activate and deactivate the mediation policy on demand.

7. The method of claim 1, wherein one or more users of the network are each associated with a unique mediation policy.

8. The method of claim 1, wherein an administrator schedules application of the mediation policy for one or more specific days of the week or one or more specific periods of time.

9. The method according to claim 1, wherein prevent includes:
receiving a request to access Internet content from a computing system coupled to the Internet service; and
blocking a resolution performed by a DNS server when the mediation policy is enabled.

10. The method according to claim 9, wherein blocking includes blocking a resolution performed by an Internet service provider if the request is received during the predetermined period of time.

11. The method according to claim 1, further comprising outputting a notification that access to the Internet content is prohibited.

12. The method of claim 11, wherein the notification provided when an end user attempts to access blocked Internet content is customized for the end user.

13. The method of claim 1, wherein the Internet service applies the mediation policy to a user device.

14. The method of claim 1, wherein the Internet service applies the mediation policy to a gateway device mediating the display of Internet content to a user device.

15. The method of claim 1, wherein a portion of the Internet service resides on a user device.

16. The method according to claim 1, wherein the Internet content includes any of a domain, a video, audio, and an application.

17. The method according to claim 1, wherein an administrator specifies different mediation policies for different locations.

18. A system for mediating an Internet service, the system comprising:
a memory for storing a mediation policy application, the mediation policy application including a user interface module stored in memory and executable by the processor to establish a user interface between a computing system and the Internet service, the user interface being further adapted to receive a request to apply the mediation policy to the Internet service; and
a processor for executing the mediation policy application to selectively apply, on-demand, a mediation policy to the Internet service, the mediation policy adapted to prevent the delivery of Internet content for a predetermined period of time.

19. The system according to claim 18, wherein the mediation policy application includes an access module stored in memory and executable by the processor to establish a password that selectively controls access to the user interface.

20. The system according to claim 19, wherein the access module is adapted to evaluate requests to access the user interface, the requests including input indicative of a password.

21. The system according to claim 20, wherein the mediation policy application includes a policy application module stored in memory and executable by the processor to apply the mediation policy in response to a request to apply the mediation policy received by the user interface.

22. The system according to claim 18, wherein the mediation policy application includes a dynamic enforcement engine stored in memory and executable by the processor to:
receive a request to access Internet content from a user device coupled to the Internet service; and
block a resolution performed by a DNS server when the mediation policy is applied to the Internet service.

23. The system according to claim 22, wherein block includes block a resolution performed by an Internet service provider when the mediation policy is applied to the Internet service.

24. The system according to claim 22, further comprising outputting a notification that access to the Internet content is prohibited.

25. The system according to claim 18, wherein the Internet content includes any of a domain, a video, audio, and an application.

26. The system according to claim 18, wherein at least one element of the mediation policy is resident on a DNS server.

27. The system according to claim 18, wherein at least one element of the mediation policy is enforced by a DNS server.

28. The system of claim 18, wherein the Internet service applies the mediation policy to a user device.

29. The system of claim 18, wherein the Internet service applies the mediation policy to a gateway device mediating the display of Internet content to a user device.

30. The system according to claim 18, wherein at least one element of the mediation policy is resident on a DNS server.

31. The system according to claim 18, wherein at least one element of the mediation policy is enforced by a DNS server.

32. The system of claim 18, wherein elements of the Internet service reside on a user device.

33. The system according to claim 18, wherein an administrator specifies different mediation policies for different locations.

34. A non-transitory computer readable storage medium having a program embodied thereon, the program executable by a processor in a computing system, the method comprising:
executing instructions stored in a memory by a processor to selectively apply, on-demand, a mediation policy to the Internet service, the mediation policy adapted to prevent the delivery of Internet content for a predetermined period of time;
establishing a password for controlling access to a user interface;
providing access to the user interface upon receipt the password from a computing system operatively coupled to the Internet service;
receiving a request to selectively apply the mediation policy to the Internet service via the user interface; and
applying the mediation policy to the Internet service.

35. A method for mediating an Internet service at a selected location, the method comprising:
establishing a user interface between a computing system and the Internet service via a DNS server;
receiving a request to access the Internet service via the user interface; and
applying a mediation policy in response to the request by executing via a DNS server instructions stored in a memory to selectively apply, on-demand, the mediation policy to the Internet service, the mediation policy being adapted to completely prevent the delivery of Internet content for a predetermined period of time.

36. The method according to claim 35, wherein the mediation policy is established and altered only by the administrator.

37. The method according to claim 35, wherein before establishing the user interface between a computing system and Internet service, the method includes receiving information authenticating the received information.

38. The method according to claim 35, wherein the administrator can activate and deactivate the mediation policy on demand.

39. The method according to claim 35, wherein one or more users of the network are each associated with a unique mediation policy.

40. The method according to claim 35, wherein the administrator schedules application of the mediation policy for one or more specific days of the week or one or more specific periods of time.

41. The method according to claim 35, wherein prevent includes:
receiving a request to access Internet content from a computing system coupled to the Internet service; and
blocking a resolution performed by a DNS server when the mediation policy is enabled.

42. The method according to claim 41, wherein blocking includes blocking a resolution performed by an Internet service provider if the request is received during the predetermined period of time.

43. The method according to claim 35, further comprising outputting a notification that access to the Internet content is prohibited.

44. The method according to claim 43, wherein the notification provided when an end user attempts to access blocked Internet content is customized for the end user.

45. The method according to claim 35, wherein the Internet content includes any of a domain, a video, audio, and an application.

46. The method according to claim 35, wherein a portion of the Internet service resides on a user device.

47. The method according to claim 35, wherein an administrator specifies different mediation policies for different locations.

48. A system for mediating an Internet service, the system comprising:
a memory for storing a mediation policy application, the mediation policy application including a user interface module stored in memory and executable by the processor to establish a user interface between a computing system and a DNS server, the user interface being further adapted to receive a request to apply the mediation policy to the Internet service; and
a processor for executing the mediation policy application to selectively apply via the DNS server, on-demand, a mediation policy to the Internet service, the mediation policy adapted to prevent the delivery of Internet content for a predetermined period of time.

49. The system according to claim 48, wherein the mediation policy application includes an access module stored in memory and executable by the processor to establish a password that selectively controls access to the user interface.

50. The system according to claim 49, wherein the access module is adapted to evaluate requests to access the user interface, the requests including input indicative of a password.

51. The system according to claim 50, wherein the mediation policy application includes a policy application module stored in memory and executable by the processor to apply the mediation policy in response to a request to apply the mediation policy received by the user interface.

52. The system according to claim 48, wherein the mediation policy application includes a dynamic enforcement engine stored in memory and executable by the processor to:
receive a request to access Internet content from a user device coupled to the Internet service; and
block a resolution performed by a DNS server when the mediation policy is applied to the Internet service.

53. The system according to claim 52, wherein block includes block a resolution performed by an Internet service provider when the mediation policy is applied to the Internet service.

54. The system according to claim 52, further comprising outputting a notification that access to the Internet content is prohibited.

55. The system according to claim 48, wherein the Internet content includes any of a domain, a video, audio, and an application.

56. The system according to claim 48, wherein a portion of the Internet service resides on a user device.

57. The system according to claim 48, wherein an administrator specifies different mediation policies for different locations.
